(19) United States
(12) Patent Application Publication
(10) Pub. No.: US 2022/0101819 A1
(43) Pub. Date: Mar. 31, 2022

(54) SLIDE MECHANISM TO ROTATE POTENTIOMETER ON ELECTRIC GUITAR

(71) Applicant: Scott David Reiner, Bergen, NY (US)

(72) Inventor: Scott David Reiner, Bergen, NY (US)

(21) Appl. No.: 17/239,562

(22) Filed: May 19, 2021

Related U.S. Application Data
(60) Provisional application No. 62/704,313, filed on May 4, 2020.

(51) Int. Cl. G10H 1/055; G10H 1/46

(52) U.S. Cl. CPC G10H 1/055; G10H 2220/265; G10H 1/46

(57) ABSTRACT

Mechanism that converts a rotary knob (potentiometer) motion on an electric guitar, into a linear sliding motion. The sliding motion can be easily manipulated by the strumming or picking hand of the musician while simultaneously playing the instrument. This mechanism allows an electric guitarist to make sweeping motions with the picking hand while playing to create musical effects with the tone control known as a “wah wah” sound, or “boo wah” sound, and the volume control to create effects known as “volume swells” or volume “tremolo”. The way this mechanism works is by pushing and pulling on a finger loop that is positioned for easy access, the finger loop is fastened to a trolley that has two bearings on it that roll in a track in the main body. The trolley has a gear rack fastened to it and that gear rack rotates a gear that is fastened to the knob stem on the potentiometer, and the action will rotate the potentiometer to its full range. This mechanism can be installed inside of a guitar body with minor modification. It can also be installed easily and without modification to a Telecaster style electric guitar as an external apparatus.

### BACKGROUND OF INVENTION

This idea came about due to the inventor seeing several guitarists adjusting the tone knob (potentiometer) and the volume knob (potentiometer) while playing the instrument to add effect to the sound on an electric guitar. The tone adds a “wah wah” or “boo wah effect and the volume adds a “volume swell” or volume “tremolo” effect. The idea with this invention is to make this much easier to control the tone and volume control while playing the instrument. The invention will allow the musician to continue strumming or picking as you adjust or manipulate a linear slide with your pinky or ring finger by pulling and pushing it.

### SUMMARY OF INVENTION

This invention is a device that controls the rotary volume and tone controls (potentiometers) on an electric guitar and translates it to a slide linear motion (fader) that is manipulated while playing the instrument. It would mount to, or be installed into the body of the guitar and solves the problem of having to reach and remove your hand from the picking and strumming area to manipulate the rotary controls to create a musical effect. This invention is used with your pinky or ring finger as the instrument is strummed or picked and the musician can manipulate the controls.

### BRIEF DESCRIPTION OF THE DRAWINGS

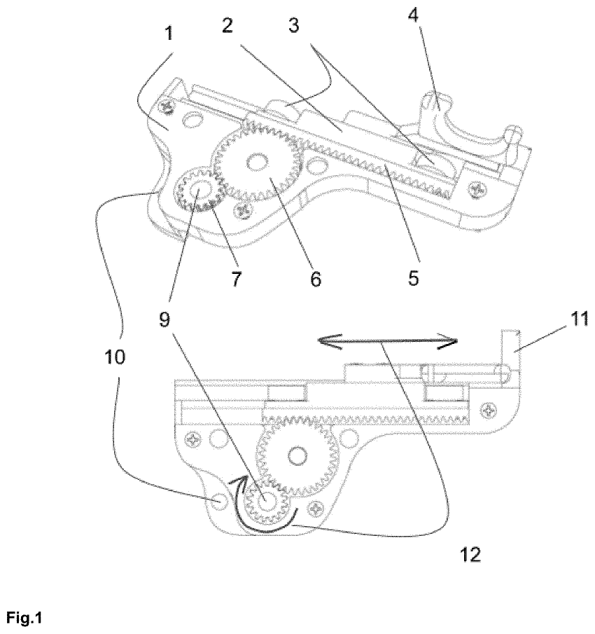

Reference FIG. 1 External Mount Mechanism

1—Main housing frame. This is the part that houses all of the gears and has the points of attachment for mounting on the guitar. There is an upper half that fastens to the lower portion that helps contain the internal parts. The main housing frame bottom is machined from aluminum and the upper housing machined from ABS plastic or aluminum.

2—Bearing Trolley. This has wheel bearings mounted to it, the finger loop mounted to it and a gear rack fastened to it. Machined from aluminum.

3—Wheel Bearings. Purchased part similar to a bearing that would be found on a router bit.

4—Finger Loop. This is used by placing your pinky or ring finger in it to push and pull. It is fastened to the bearing trolley and has some adjustability. Machined from aluminum.

5—Gear Rack. Purchased from plastic stock and machined for mounting and cut to length.

6—Middle Gear. Modified purchased part made from nylon.

7—Knob Stem Gear. Purchased or machined brass part modified and a set screw added.

9—Area where electric guitars knob stem fastens to gear.

10—Through hole in the main housing frame where the guitar control panel screw is reinstalled to hold the slide mechanism and control plate on.

11—Slot area with set screw on underside to fasten to the guitar bridge plate.

12—Directional arrows showing the slide of the fingerloop and rotation of the potentiometer.

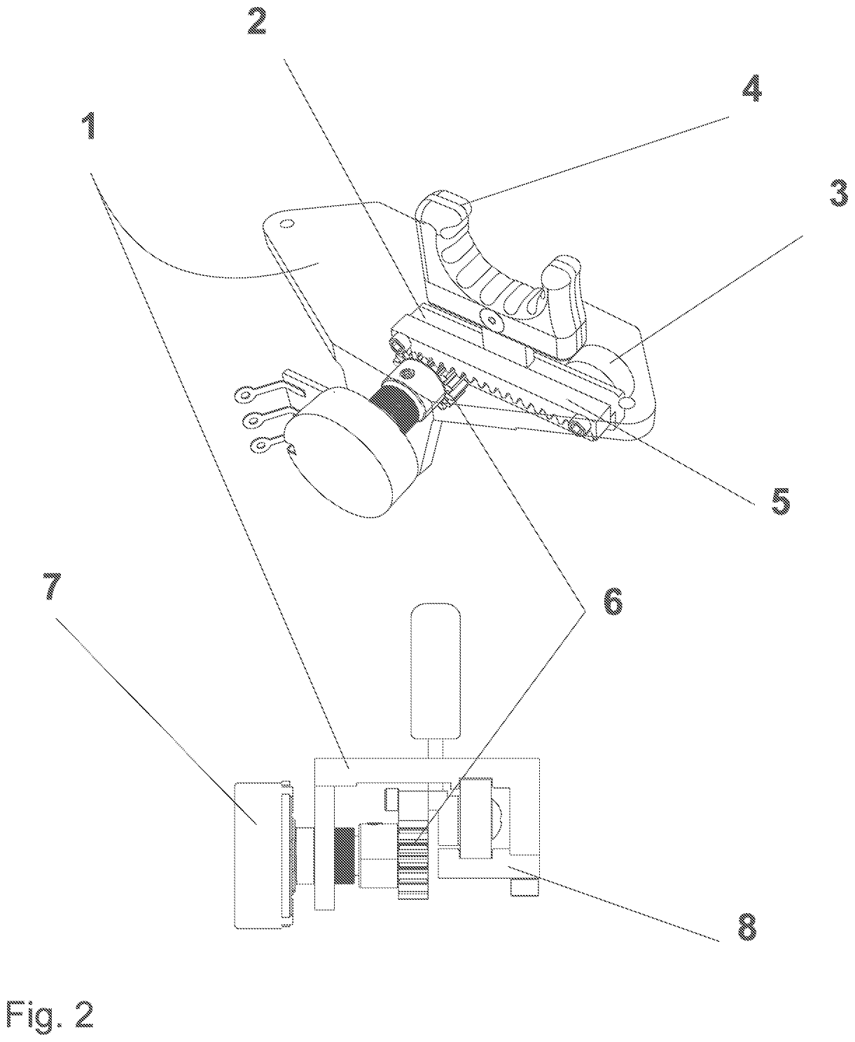

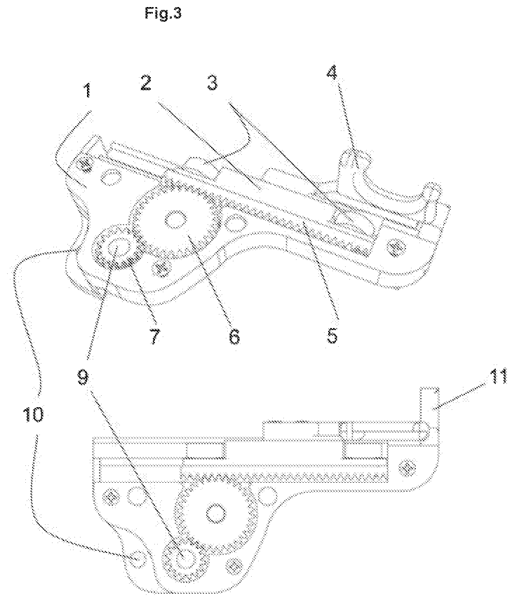

Reference FIG. 2 Internal Mount Mechanism

1—Main housing frame. This is the part that houses all of the gears and has the points of attachment for mounting on the guitar. There is an upper half that fastens to the lower portion that helps contain the internal parts. The main housing frame is machined from aluminum

2—Bearing Trolley. This has wheel bearings mounted to it, the finger loop mounted to it and a gear rack fastened to it. Machined from aluminum.

3—Wheel Bearings. Purchased part similar to a bearing that would be found on a router bit.

4—Finger Loop. This is used by placing your pinky or ring finger in it to push and pull. It is fastened to the bearing trolley and has some adjustability. Machined from aluminum.

5—Gear Rack. Purchased from plastic stock and machined for mounting and cut to length.

6—Knob Stem Gear. Purchased or machined brass part modified and a set screw added.

7—Potentiometer.

8—Bottom housing track for bearing to travel in.

### DETAILED DESCRIPTION

Mechanism that converts rotary knob (potentiometer) into a linear sliding motion. The way this mechanism works is by pushing and pulling on a finger loop, the finger loop is fastened to a trolley that has two bearings on it that roll in a track in the main body. The trolley has a gear rack fastened to it and that gear rack rotates a gear that is fastened to the knob stem on the potentiometer, and the action will rotate the potentiometer to its full range. This mechanism can be installed inside of a guitar body with minor modification. It can also be installed easily and without modification to a Telecaster style electric guitar as an external apparatus. This mechanism will control a potentiometer such as tone or volume controls. The idea is to adjust the tone or volume control without moving your hand down toward the control panel, as it is done by guitarists currently, thus making it much easier to create a desired effect. You can easily make these adjustments while strumming or plucking the guitar. The idea for this mechanism is, you can coordinate your hand motion as you play to slide the finger loop at different rates of speed and distance that will shape the tone frequency or volume level to create a desired musical effect. This mechanism can either be installed into an electric guitar with some minor modifications or easily fastened to an electric guitar, specifically a Telecaster style by removing the tone knob and then placing the mechanism on the guitar and tightening screws.

The manufacturing of this invention can be done in production quantities with CNC machining aluminum and brass. The assembly includes some off the shelf fasteners and bearings. Some of the parts will be plated or anodized. Prototypes have been made of the external mount and internal mount versions, and work exactly as described.

1. This mechanism converts a normal rotary potentiometer (volume and/or tone knob) into a slide (fader) linear motion on an electric guitar. The position of the slide control allows easy manipulation of the tone and volume controls while the strumming and picking hand is in position.

2. This mechanism as described in claim one can be used as part of a performance to create musical effects by manipulating the tone control for a “wah wah sound”, and volume control for “volume swells” or volume “tremolo”

3. This mechanism can be installed into the body of the guitar or installed as an external apparatus with little to no modification.
